(19) United States
(12) Patent Application Publication
(10) Pub. No.: US 2011/0058511 A1
(43) Pub. Date: Mar. 10, 2011

(54) METHOD FOR TRANSMITTING DATA OF MULTICAST BROADCAST SERVICE USING SUPERFRAME HEADER IN MOBILE WIRELESS CONNECTION SYSTEM

(75) Inventors: Eunkyung KIM, Seoul (KR); Jae Sun CHA, Daejeon-si (KR); Sung Cheol CHANG, Daejeon-si (KR); Chul Sik YOON, Seoul (KR)

(73) Assignee: Electronics and Telecommunications Research Institute, Daejeon (KR)

(21) Appl. No.: 12/878,487

(22) Filed: Sep. 9, 2010

(30) Foreign Application Priority Data
Sep. 9, 2009 (KR) 10-2009-0084734
Sep. 9, 2010 (KR) 10-2010-0088568

(51) Int. Cl. H04H 20/71

(52) U.S. Cl. 370/312

(57) ABSTRACT

There is provided a method of transmitting multicast broadcast service (MBS) data using a superframe including a plurality of subframes in a mobile wireless connection system, the method including transmitting MBS MAP indication information indicating the first at least one first resource unit of an MBS region in the beginning of an MBS scheduling interval (MSI) and MBS control information including subframe offset information; transmitting an MBS MAP through the first resource unit; and transmitting an MBS burst indicated by the MBS MAP, wherein the subframe offset information including an index of the subframe at a point where the MBS burst is ended.

### CROSS-REFERENCE TO RELATED APPLICATIONS

This application claims the benefit of priority of Korean Patent Application No. 10-2009-0084734 filed on Sep. 9, 2009 and Korean Patent Application No. 10-2010-0088568 filed on Sep. 9, 2010, which are incorporated by reference in their entirety herein.

### BACKGROUND

1. Field of the Invention

The present invention relates to a mobile wireless access system supporting a mobile multicast broadcast service, and more particularly to a method of providing a multicast broadcast service using a superframe header.

2. Related Art

3GPP (3rd Generation Partnership Project) LTE (long term evolution) and IEEE (Institute of Electrical and Electronics Engineers) 802.16m have been developed as a candidate for the next-generation wireless communication system. The 802.16m standard has two aspects, modification from the existing 802.16e standards as continuity from the past and standards for the next-generation international mobile telecommunications (IMT)-Advanced system as continuity to the future. Accordingly, the 802.16m standard has to not only keep compatibility with a mobile WiMAX system based on the 802.16e standard but also satisfy all advanced requirements for the IMT-Advanced system.

The wireless communication system generally uses one bandwidth for transmitting data. For example, a second-generation wireless communication system uses a bandwidth of 200 KHz˜1.25 MHz, and a third-generation wireless communication system uses a bandwidth of 5 MHz˜10 MHz. To support increased transmission capacity, the 3GPP LTE or 802.16m has recently continued to increase the bandwidth up to 20 MHz or higher. The increase of the bandwidth is necessary for increasing the transmission capacity, but it may cause high power consumption if supporting a broad bandwidth even when a required service level is low.

The IEEE 802.16m system supports evolved multicast broadcast service (E-MBS, which can be simply called MBS). The E-MBS is a point-to-multipoint system where data packets are simultaneously transmitted from one source to a plurality of destinations. The broadcast means capability for transmitting contents to all users. The multicast means contents directed toward a certain group of users subscribed for receiving a certain service. Here, it is possible to support static multicast and dynamic multicast.

If a base station provides the MBS and one base station manages many MBS zones, in the worst case, system information may have to be updated per period of the superframe header transmitted from the base station. Further, if the system does not notify what subframe is an MBS subframe, even a mobile station that receives only a unicast service performs decoding the MBS subframe. In this case, the unicast mobile station cannot perform decoding this subframe. Therefore, if this operation is repeated, the unitcast mobile station determines that there is a problem in synchronization with the system, and unnecessarily performs the update for the synchronization. Accordingly, there is needed a method of transmitting MBS data without unnecessarily performing the update.

### SUMMARY

The present invention is to efficiently provide a multicast broadcast service (MBS) using an MBS MAP message and an MBS frame.

In an aspect of the present invention, there is provided a method of transmitting multicast broadcast service (MBS) data using a superframe including a plurality of subframes in a mobile wireless connection system, the method including: transmitting MBS MAP indication information indicating the first at least one first resource unit of an MBS region in the beginning of an MBS scheduling interval (MSI) and MBS control information including subframe offset information; transmitting an MBS MAP through the first resource unit; and transmitting an MBS burst indicated by the MBS MAP, wherin the subframe offset information including an index of the subframe at a point where the MBS burst is ended.

In another aspect of the present invention, there is provided a method of receiving multicast broadcast service (MBS) data by a mobile station using a superframe including a plurality of subframes in a mobile wireless connection system, the method including: receiving MBS MAP indication information indicating the first at least one first resource unit of an MBS region in the beginning of an MBS scheduling interval (MSI) and MBS control information including subframe offset information; receiving an MBS MAP through the first resource unit; and receiving an MBS burst indicated by the MBS MAP, wherein the subframe offset information including an index of the subframe at a point where the MBS burst is ended.

According to the present invention, a system update may be minimized in a mobile wireless access system supporting the MBS, and the MBS service may be more efficiently provided and con tenuously managed.

### BRIEF DESCRIPTION OF THE DRAWINGS

FIG. 1 shows a wireless communication system.

FIG. 2 shows a frame structure and a data transmission method used in a mobile wireless access system supporting a multicast broadcast service.

FIG. 3 is a flowchart showing an MBS data transmission method according to an exemplary embodiment of the present invention.

FIG. 4 shows an example of an MBS frame structure according to an exemplary embodiment of the present invention.

### DESCRIPTION OF EXEMPLARY EMBODIMENTS

Below, exemplary embodiments of the present invention will be described in detail with reference to accompanying drawings. In giving reference numerals to elements of the respective drawings, it will be noted that the same reference numerals refer to the same elements even though they are shown in different drawings. Further, detailed descriptions may be omitted if it is determined that the detailed descriptions about relevant well-known configuration or function may be beside the point of the present specification while describing the exemplary embodiments of this specification.

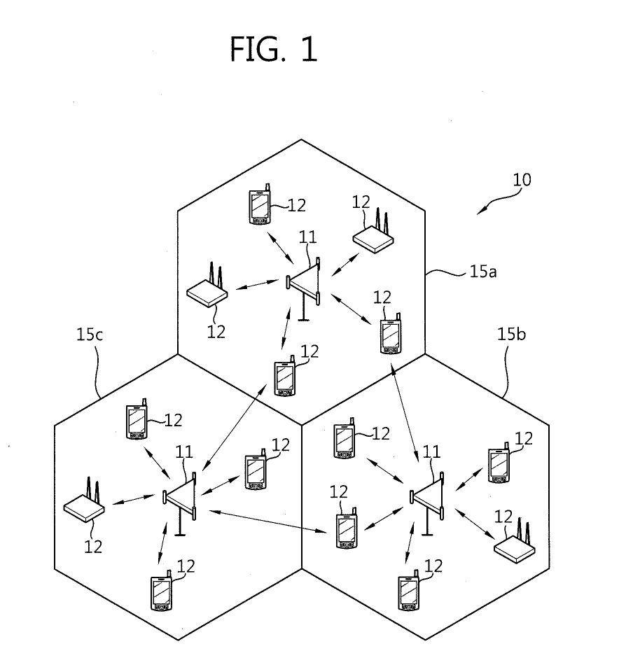

FIG. 1 shows a wireless communication system.

Referring to FIG. 1, a wireless communication system 10 includes at least one base station (BS) 11. Each BS 11 provides a communication service to certain local regions (generally called cells) 15a, 15b and 15c. Also, the cell may be divided again into a plurality of regions (also called sectors). A mobile station (MS) 12 may be fixed or mobile, which may also be called user equipment (UE), a motile terminal (MT), a user terminal (UT), a subscriber station (SS), a wireless device, a personal digital assistant (PDA), a wireless modem, a handheld device, etc. The BS 11 generally refers to a fixed station to communicate with the MS 12, which may also be called an evolved-node B (eNB), a base transceiver system (BTS), an access point (AP), etc. Further, a packet flow of uplink or downlink between the BS and MS is called a service flow.

A multicast broadcast service (MBS) has certain quality of service (QoS) and one service flow, and is provided as being simultaneously mapped to many users. To receive the MBS, a user receiving the corresponding service sets up a parameter and a service flow. The BS providing the MBS belongs to a specific MBS zone, and common contents transmitted based on the corresponding service flow are transmitted as being divided by multicast identifiers (IDs) (multicast station identifier (STID) or E-MBS ID, hereinafter referred to as the E-MBS ID) within each MBS zone. The E-MBS ID is a common ID assigned to a corresponding user for receiving the MBS service. At this time, the MBS contents are transmitted to a region divided as one zone, in which each MBS zone is divided by an MBS zone ID. This content has one channel or service flow ID (FID). At this time, the FID forms a pair with the relevant E-MBS ID, which is assigned to each MBS connection. One user may be assigned with many FIDS, and the MBS contents that belong to one E-MBS ID may be transmitted as being distinguished by the FID.

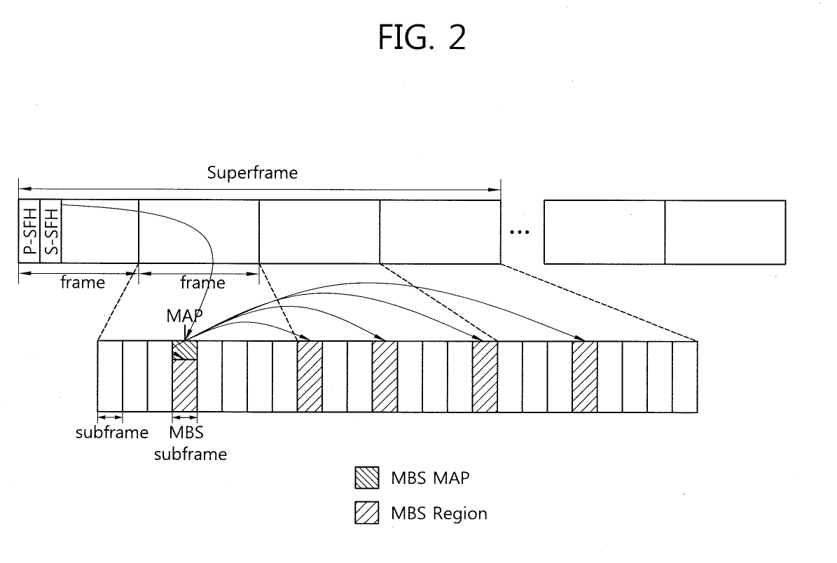

FIG. 2 shows a frame structure and a data transmission method used in a mobile wireless access system supporting the MBS.

Referring to FIG. 2, a superframe may include four frames. Each frame includes a plurality of subframes. Each superframe includes a suferframe header (SFH), in which the SFH is a unit of transmitting a plurality of frames and transmitted to the MS while including essential system parameters and system configuration information.

A primary superframe header (P-SFH) may be transmitted per superframe, and may be included in the first subframe of each superframe. The P-SFH defines whether to transmit or change the secondary superframe header (S-SFH), and a transmission period may correspond to one or more superframes. The P-SFH may allow the MS to acquire the latest essential system parameters and system configuration information applied to the system on the basis of an S-SFH change count and an S-SFH change bitmap.

The system parameters and the system configuration information are updated as follows. The MS receives and stores the S-SFH change count and S-SFH change bitmap included in the P-SFH. If a previously stored S-SFH change count is equal to a newly received S-SFH change count, the S-SFH may not be updated since a previously received S-SFH and a newly received S-SFH are the same information. On the other hand, if a previously stored S-SFH change count is not equal to a newly received S-SFH change count, it is determined that system information is updated. At this time, it is ascertained whether difference in a bit number between a previously stored S-SFH change bitmap and a newly received S-SFH change bitmap is equal to difference between the previously received S-SFH change count and the newly received S-SFH change count. If the two differences are the same, it is determined that the system information of the BS and the system information received by the MS are synchronized with each other, and thus the MS updates the system information by receiving an S-SFH subpacket shown as changed from the S-SFH change bitmap. If the two differences are not the same, it is determined that the system information of the BS and the system information received by the MS are not synchronized with each other, and thus the MS updates the system information by receiving all S-SFH subpackets.

In the case that unicast data and multicast data are divided and transmitted by time division multiplexing (TDM), a specific subframe (e.g., an MBS region) is assigned for transmitting MBS data. A transmission format and size of MBS data may be informed through an MBS MAP message, and the MBS MAP may be included per subframe where the MBS data is carried or may be included periodically. A location of the

MBS MAP may be informed by the SFH (generally, S-SFH), and the location of the MBS MAP to be next transmitted may be informed through the MBS MAP as well as the SFH. A certain pattern appears in the system between the MBS MAP and the following MBS MAP, and this certain pattern is called an MBS scheduling interval (MSI). Every MBS zone may have one MSI. One BS may manage one or more MBS zones and MSIs. Accordingly, the MSs initiating the MBS service operates in such a manner to receive MBS data by ascertaining a location of the first MBS MAP from the S-SFH, and then receive an MBS MAP, thereby searching the next MBS MAP.

By the way, if the transmission period of the S-SFH is not equal to the transmission period of the MBS MAP, a transmission location of the MBS MAP has to be informed through the system information of the S-SFH. However, the system information may be changed per S-SFH transmission period. In this case, if the BS manages many MBS zones, in the worst case it is inefficient since the system information may need to be updated from the BS per S-SFH period.

Further, if it is not informed by the system what subframe is the MBS subframe, even the MS receiving only the unicast service performs decoding the MBS subframe. If so, the unicast terminal cannot perform decoding the subframe since the MBS subframe includes no map information element (IE). Therefore, if this operation is repeated, the unicast MS determines that there is a problem in synchronization with the system, and unnecessarily performs the update for the synchronization.

Below, a method of transmitting MBS data with a minimum system update will be described.

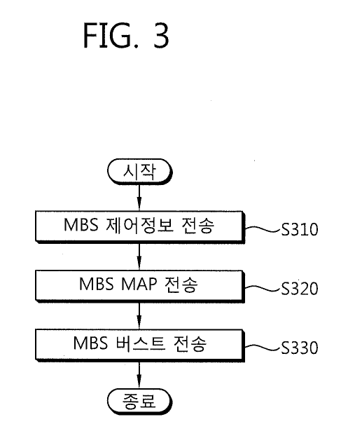

FIG. 3 is a flowchart showing an MBS data transmission method according to an exemplary embodiment of the present invention.

Referring to FIG. 3, MBS MAP indication information indicating the first at least one first resource unit of an MBS region in the beginning of the MSI and MBS control information including subframe offset information are transmitted (S310). The MBS MAP is transmitted through the first resource unit (S320). An MBS burst indicated by the MBS MAP is transmitted (S330).

The MBS MAP may be received on the basis of the MBS MAP indication information, and the MBS MAP may be transmitted through the first at least one resource unit of the MBS region in the beginning of the MSI. The MBS region may be informed through the SFH-SP2 and system configuration descriptor (SCD) message.

Here, the MBS MAP may include the MBS MAP indication information that indicates the location of the following MBS MAP. The first MBS MAP may be received from only the SFH, but there is no need of acquiring information about the MBS MAP from the SFH next time since the MBS MAP indicates the following MBS MAP. Accordingly, there is no need of continuously updating the SFH.

Also, the MBS MAP includes MBS region indication information that indicates the MBS region about the FID on the basis of information about the E-MBS ID and FID. Below, the MBS region indication information will be described in detail.

At this time, the MBS MAP indication information may be transmitted through a control message instead of the SFH. For example, the MBS MAP indication information may be transmitted through a MAC management message, a MAC header, a map information element, or a control channel. Also, the MBS MAP indication information may be transmitted through both the SFH and the control message.

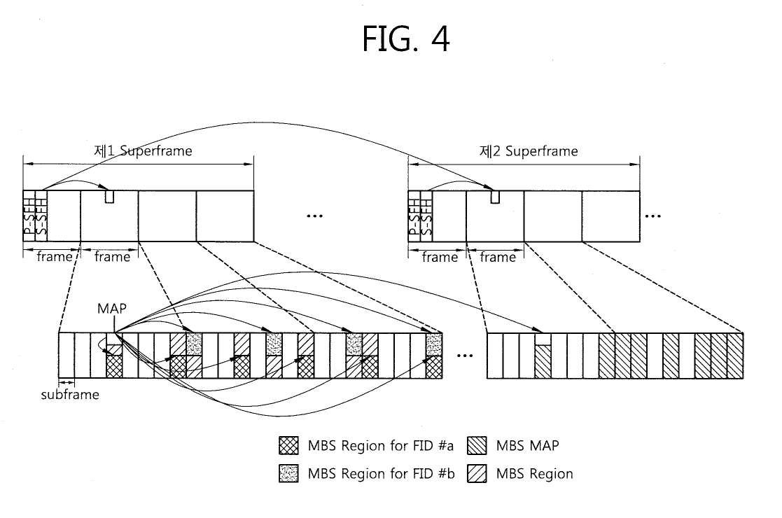

FIG. 4 shows an example of an MBS frame structure according to an exemplary embodiment of the present invention.

Referring to FIG. 4, to minimize the system update of the S-SFH, the SFH includes the MBS MAP indication information first transmitted after transmission of the S-SFH and parameters related to the transmission. Here, the MBS MAP indication information is information of indicating the location of the MBS MAP to be transmitted next time, which may include a superframe number, a frame index, a subframe index, a modulation and coding scheme (MCS), and resource information. Table 1 shows the format of the SFH.

TABLE 1

| Syntax | Size (bits) | Notes |
|---|---|---|
| SFH IE ( ) { | | |
| . . . | | |
| Next MBS MAP Point IE ( ) | | Table 2 |
| . . . | | |
| } | | |

Table 2 shows the MBS MAP indication information.

TABLE 2

| | Size | |
|---|---|---|
| Syntax | (bits) | Notes |
| Next MBS MAP Point | | |
| IE ( ) { | | |
| Superframe Number | [TBD] | |
| Frame Index | 2 | 0b00: 1^{st} frame |
| | | 0b01: 2^{nd} frame |
| | | 0b10: 3^{rd} frame |
| | | 0b11: 4^{th} frame |
| Subframe Index | 3 | 0b000: 1^{st} subframe of the |
| | | frame |
| | | 0b001: 2^{nd} subframe of the |
| | | frame |
| | | 0b010: 3^{rd} subframe of the |
| | | frame |
| | | 0b011: 4^{th} subframe of the |
| | | frame |
| | | 0b100: 5^{th} subframe of the |
| | | frame |
| | | 0b101: 6^{th} subframe of the |
| | | frame |
| | | 0b110: 7^{th} subframe of the |
| | | frame |
| | | 0b111: 8^{th} subframe of the |
| | | frame |
| MCS | [4] | MCS depends on supported |
| | | modes, 16 modes. |
| Resource Information | | |
| } | | |

Here, the superframe number refers to a least significant bit (LSB) of a superframe number of the MBS MAP to be transmitted next time, and the MSI may be set as a power of 2 for more efficient transmission. The frame index is an index for indicating a location of a frame where the MBS MAP to be transmitted next time is located among the frames included in the superframe indicated by the superframe number. The subframe index is an index for indicating a location of a subframe where the MBS MAP to be transmitted next time is located among the subframes included in the frame indicated by the frame index. The MCS refers to a modulation and coding scheme for the MBS MAP to be transmitted next time, and is varied depending on supported modes. The supported modes are 16 modes. The resource information refers to MBS region resource information of the MBS MAP to be transmitted next time.

The SFH of the first superframe may indicate a transmission location of the MBS MAP included in the second superframe. The MBS MAP indicates the MBS region of the second superframe, and the MBS MAP itself is also included in the second superframe. At this time, the SFH includes the MBS MAP indication information comprising the transmission location of the MBS MAP included in the second superframe, thereby indicating the transmission location of the MBS MAP. In this case, because the first MBS MAP is indicated by the SFH of the previous superframe, there is no need of updating the SFH to separately indicate the MBS MAP. Accordingly, there is no need of updating the S-SFH per superframe. Here, the second superframe is nothing but an example. Alternatively, the SFH of the first superframe may indicate the MBS MAPS included in the third and fourth superframes.

The SFH may be updated with new information after transmitting information about the MBS MAP to be transmitted next time.

The MBS MAP may include the MBS MAP indication information and the MBS region indication information for indicating the MBS region. The following Table 3 shows the format of the MBS MAP message.

TABLE 3

| | Size | |
|---|---|---|
| Syntax | (bits) | Notes |
| MBS MAP Message format ( ) { | | |
| MBS Region IE ( ) | | Table 4 |
| Next MBS MAP Point IE ( ) | | Table 2 |
| Number of E-MBS ID (i) | [TBD] | |
| For (i=0;i<Number of E-MBS | | |
| ID; i++) { | | |
| E-MBS ID | 12 | |
| Number of FID (k) | [TBD] | |
| For (k=0;k<umber of | | |
| FID; k++) { | | |
| FID | 4 | |
| Frame offset for MBS | 2 | 1: current frame |
| region | | 2: (current frame |
| | | +1) th frame |
| | | . . . |
| | | N: (currentframe+n- |
| | | 1) th frame |
| Subframe offset for MBS | 3 | 0b000: 1st subframe |
| Region | | of the frame |
| | | . . . |
| | | 0b111: 8th subframe |
| | | of the frame |
| MCS | [4] | MCS depends on |
| | | supported mode, 16 |
| | | modes. |
| Resource Information | | |
| Allocation pattern | | |
| } | | |

The MBS MAP may include the number of E-MBS IDs, and if there is a plurality of E-MBS IDs, the MBS MAP may include values of the respective E-MBS IDs. Also, the MBS MAP may include the transmission location and resource information of the MBS MAP to be transmitted next time, or the superframe number, frame index and MCS included in the SFH. At this time, the number of E-MBS IDs is the number of E-MBS IDs managed by the BS or the number of E-MBS IDs indicated by the MBS MAP.

If there is a plurality of FIDs, the MBS MAP may include the number of FIDs and each value of FID with respect to each E-MBS ID. At this time, the number of FIDs is a total number of FIDs corresponding to the service flow per relevant E-MBS ID or the number of FIDs shown in the current MBS MAP with regard to the relevant E-MBS ID.

Referring to the table 3, the frame offset for the MBS region, the subframe offset for the MBS region, the MCS, the resource information, and the allocation pattern for transmitting the relevant MBS region are provided with regard to each FID.

Here, the frame offset refers to a frame location of the MBS region to be first transmitted after the MBS MAP is transmitted with respect to each FID. The subframe offset refers to a subframe location of the MBS region to be first transmitted after the MBS MAP is transmitted with respect to each FID. Also, the subframe offset includes an index of a subframe at a point where the MBS burst is ended, and the first subframe of the first frame is reserved for transmitting the superframe header. Here, any MBS burst is not transmitted through the superframe header. The bit number of the subframe offset may be 6 bits if the MSI is 0b00, 7 bits if the MSI is 0b01, 8 bits if the MSI is 0b10, and 9 bits if the MSI is 0b11. The index of the subframe offset may start in the beginning of the MSI.

In this exemplary embodiment, the frame offset and the subframe offset are included in the MBS MAP, but it is just an example. Alternatively, the frame offset and the subframe offset may be included in other control information, e.g., a MAC management message, a MAC header, an MBS information element, or a control channel.

The MCS refers to the modulation and coding scheme of the MBS region with regard to the FID. The resource information includes data within the MBS region or information about a frequency resource index of the MBS MAP. The information about the frequency resource index is a location of an index of a subband logical resource unit (SLRU) where the E-MBS burst is ended. The resource information may include the location of the index of the SLRU. The first MBS stream may start in the SLRU next to the MBS MAP within the MBS region. The MBS resource information indexes the SLRU of the subframe in the MBS region indicated by a zone allocation bitmap transmitted through an SCD message. The allocation pattern for transmitting the MBS region may appear as a period or the like. If only the first pattern is known (e.g., if information about the allocation pattern for the first MBS region is included in the MBS MAP) in the case that the pattern is repetitive, information about the following FID may be known even though it is not received.

There are various methods using the MBS region indication information for indicating the MBS region. In the same method as the S-SFH indicates the MBS MAP, the superframe number, the frame index, the subframe index, etc. may be used for the indication. On the contrary, without using the superframe number, it may be transmitted using the frame offset and the subframe offset for each FID or it may be represented with only offset information of the subframe. Lastly, when information about the MBS region is represented it may be regarded that the MBS MAP is transmitted to the first frame (i.e., the current frame) and the last frame of the relevant MBS region, or the MBS MAP is transmitted in the beginning of every MBS region.

At this time, the MBS MAP indicating the MBS data burst about each FID may include not only a location where the MBS burst is first transmitted, but also information about time to transmit the MBS burst and a transmission parameter of the MBS burst. Here, the information about time to transmit the following MBS burst may include the transmission interval, period, etc. of the MBS burst. Also, the next MBS burst may be transmitted following the previous MBS bust. That is, the MBS bursts may be sequentially transmitted in accordance with the FIDS after the MBS MAP is transmitted in the MBS region.

Table 4 shows the MBS region indication information.

TABLE 4

| Syntax | Size (bits) | Notes |
|---|---|---|
| MBS Region IE ( ) { | | |
| Superframe | [TBD] | Size is the same as MSI length |
| Bitmap | | in superframe unit |
| | | 1: multicast is included in the |
| | | superframe |
| | | 0: unicast only in the |
| | | superframe |
| Frame Bitmap | 4 * (number | Maximum length = (Number of |
| | of bit set | frame in an superframe) * |
| | in the | (length of superframe) |
| | superframe | Length = (Number of frame in |
| | bitmap) | an superframe) * (number of |
| | | set bit in the superframe |
| | | bitmap) |
| | | 1: multicast is included in the |
| | | frame |
| | | 0: unicast only in the frame |
| Subframe | (number of | Maximum length = (number of |
| Bitmap | subframe | subframe in an frame) * |
| | in an | (Maximum length of frame |
| | frame) * | bitmap) |
| | (number of | Length = (number of subframe |
| | bit set in | in an frame) * (length of frame |
| | the frame | bitmap) |
| | bitmap) | 1: multicast is included in the |
| | | subframe |
| | | 0: unicast on ly in the |
| | | subframe |
| } | | |

Here, the superframe bitmap indicates whether the superframe is used for multicast or unicast. The frame bitmap indicates whether the frame is used for multicast or unicast. The subframe bitmap indicates whether the subframe is used for multicast or unicast.

At this time, if the superframe is used for multicast, the superframe is decoded on the basis of the superframe bitmap. If the frame is used the multicast, the frame is decoded on the basis of the frame bitmap. If the subframe is used the multicast, the subframe is decoded on the basis of the subframe bitmap. Each decoding stage is performed before transmitting the MBS data after transmitting the MBS MAP. It is determined that the superframe, the frame or the subframe receives only the unicast service or receives the multicast service too, so that the unicast MS may be prevented from trying to decode the subframe. Accordingly, it is possible to solve the problem that the unicast MS repetitively fails in the decoding, determines a synchronization trouble with the system, and unnecessarily performs the update

Through the MBS region indication information, the information about the MBS region may be transmitted to the unicast MS as well as the multicast MS. It is possible to provide the MBS to an initially accessing MS, a performing handover MS, an idle mode MS, etc. The information about the region may be independently present in an MBS MAP, a MAC management message, a MAC header, a map information element or the SFH, and given to the MS. Also, the information about the region may be present simultaneously in two or more among the MBS MAP, the MAC management message, the MAC header, the map information element and the SFH.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of transmitting multicast broadcast service (MBS) data using a superframe comprising a plurality of subframes in a mobile wireless connection system, the method comprising:
transmitting MBS MAP indication information indicating the first at least one first resource unit of an MBS region in the beginning of an MBS scheduling interval (MSI) and MBS control information comprising subframe offset information;
transmitting an MBS MAP through the first resource unit; and
transmitting an MBS burst indicated by the MBS MAP,
wherein the subframe offset information comprising an index of the subframe at a point where the MBS burst is ended.

2. The method of claim 1, wherein the MBS control information is a system configuration descriptor (SCD) message.

3. The method of claim 1, wherein the MBS control information is a superframe header subpacket 2 (SFH-SP2) message.

4. The method of claim 1, wherein the MBS control information further comprises a location of an index of a subband logical resource unit (SLRU) where the MBS burst is ended

5. The method of claim 1, wherein the MBS MAP further comprises at least one of a superframe bitmap which indicates whether a superframe is used for multicast or unicast, a frame bitmap which indicates whether a frame is used for multicast or unicast, and a subframe bitmap which indicates whether a subframe is used for multicast or unicast.

6. The method of claim 5, wherein, using the superframe bitmap, the frame bitmap and the subframe bitmap, the MBS burst is transmitted by decoding the superframe if the superframe is used for multicast, by decoding the frame if the frame is used for multicast, and by decoding the subframe if the subframe is used for multicast.

7. The method of claim 1, wherein the MBS MAP indication information further comprises at least one of a superframe number for a location of a MBS MAP to be transmitted next time, a frame index and a subframe index indicating the location of the MBS MAP to be transmitted next time, a modulation and coding scheme (MCS) for the MBS MAP to be transmitted next time, and resource information.

8. The method of claim 1, wherein the MBS MAP indication information indicates so that the MBS MAP is transmitted in the beginning of every MBS region.

9. The method of claim 1, wherein the MBS MAP indicates the initial transmission location of the MBS burst, the transmission parameter of the MBS burst and a transmission location of a MBS burst to be transmitted next time, a transmission interval or a transmission period.

10. The method of claim 1, wherein the MBS burst is sequentially transmitted in accordance with flow identifiers (FID) after the MBS MAP is transmitted.

11. The method of claim 1, wherein the MBS MAP further comprises information about an allocation pattern of an MBS region in accordance with flow identifiers (FID).

12. A method of receiving multicast broadcast service (MBS) data by a mobile station using a superframe comprising a plurality of subframes in a mobile wireless connection system, the method comprising:
receiving MBS MAP indication information indicating the first at least one first resource unit of an MBS region in the beginning of an MBS scheduling interval (MSI) and MBS control information comprising subframe offset information;
receiving an MBS MAP through the first resource unit; and
receiving an MBS burst indicated by the MBS MAP,
wherein the subframe offset information comprising an index of the subframe at a point where the MBS burst is ended.

13. The method of claim 12, wherein the mobile station is a mobile station which is used for multicast or a mobile station which is used for unicast.
